(19) United States
(12) Patent Application Publication
(10) Pub. No.: US 2023/0179074 A1
(43) Pub. Date: Jun. 8, 2023

(54) Method of manufacturing a voice coil with varying height profile and electrodynamic actuator, electrodynamic transducer and speaker with such a coil

(71) Applicant: Sound Solutions International (Zhenjiang) Co., Ltd., Zhenjiang City (CN)

(72) Inventors: Gustav Otto, Vienna (AT); Friedrich Reining, Vienna (AT); Hong-Bi Dong Nguyen, Vienna (AT)

(21) Appl. No.: 17/991,445

(22) Filed: Nov. 21, 2022

(30) Foreign Application Priority Data
Dec. 3, 2021 (AT) A 50970/2021

(51) Int. Cl. H02K 41/035; H04R 9/04

(52) U.S. Cl. CPC H02K 41/0354; H04R 9/047

(57) ABSTRACT

A method of manufacturing a voice coil (1a . . . 1d) is disclosed, wherein windings (4a . . . 4g) in a first section (B1) are arranged one above the other and are arranged next to each other in a second section (B2) when viewed in said cross sectional plane (D). In a first step, a first and a second winding (4a, 4a′, 4b) of the windings (4a . . . 4g) are arranged over one another but offset sideways to each other in the second section (B2). In a second step, the first winding (4a, 4a′) is moved into a height position of the second winding (4b) in the second section (B2) by pressing and/or folding. Moreover, an electrodynamic actuator (17a . . . 17c), comprising a voice coil (1a . . . 1d) of the above kind is disclosed. Finally, an electrodynamic transducer (32a, 32b), a speaker (21) and an output device comprising such an electrodynamic actuator (17a . . . 17c) is disclosed.

### PRIORITY

This patent application claims priority from Austrian Patent Application No. A50970/2021, filed on Dec. 3, 2021, the disclosure of which is incorporated herein, in its entirety, by reference.

### BACKGROUND OF THE INVENTION

The invention relates to a method of manufacturing a voice coil having an electrical conductor in the shape of loops or windings running around a coil axis along a circumferential line. Moreover, the invention relates to an electrodynamic actuator, which is designed to be connected to a backside of a plate like structure or membrane opposite to a sound emanating surface of the plate like structure or the membrane and which comprises at least one voice coil of the above kind and a magnet system being designed to generate a magnetic field transverse to the electrical conductor in a loop section of the voice coil. The invention furthermore relates to a speaker, which comprises an electrodynamic actuator of the above kind and a membrane, which is fixed to the at least one voice coil and to the magnet system. In addition, the invention relates to an electrodynamic (acoustic) transducer, which comprises a plate like structure with a sound emanating surface and a backside opposite to the sound emanating surface. The electrodynamic transducer additionally comprises an electrodynamic actuator of the above kind, which is connected to the plate like structure on said backside. In particular, the plate like structure can be embodied as a display. In this way, the electrodynamic actuator together with the display forms an output device (for both audio and video data).

A voice coil and a method of manufacturing a voice coil generally is known. Usually, a wire is wound so that it has a helical course and forms the voice coil. Within an electrodynamic actuator, the voice coil is arranged in a magnetic field so that a force acts on the voice coil when a current flows through the electrical conductor. A movement of the voice coil relative to the magnet system caused by said force is converted into sound in an electrodynamic transducer or speaker of the above kind as is generally known. Space restrictions, especially in mobile handheld devices, lead to problems when a particular output power and sound quality shall be reached in a restricted volume. The freedom of design in particular is limited by the voice coil, which cannot be shaped into any conceivable form according to prior art technology.

### SUMMARY OF THE INVENTION

Thus, it is an object of the invention to overcome the drawbacks of the prior art and to provide a better method of manufacturing a voice coil, a better electrodynamic actuator, a better speaker, a better electrodynamic transducer and a better output device. In particular, freedom of design shall be improved so that a particular output power and sound quality can also be achieved under problematic space restrictions.

The problem of the invention is solved by a method as disclosed in the opening paragraph, wherein different windings in a first section of the circumferential line are arranged one above the other when viewed in a cross sectional plane perpendicular to the circumferential line and when the coil axis indicates a height direction, wherein said different windings in a second section of the circumferential line are arranged next to each other when viewed in said cross sectional plane and wherein the method comprises the steps of
arranging a first and a second winding of said windings over one another but offset sideways to each other in the second section in a first step, and
a) pressing the first winding into a height position of the second winding in the second section in a second step or
b) folding the first winding into a height position of the second winding in the second section in a second step or
c) moving the first winding into a height position of the second winding by means of combined folding and pressing in the second section in a second step.

As a result, the first winding and the second winding are located at the same height position or in the same plane being arranged perpendicular to the coil axis after the second step when viewed in a cross sectional plane including the coil axis.

Moreover, the problem of the invention is solved by an electrodynamic actuator as defined in the opening paragraph, wherein different windings of the electrical conductor in a first section of the circumferential line are arranged one above the other when viewed in a cross sectional plane perpendicular to the circumferential line and when the coil axis indicates a height direction and wherein said different windings of the electrical conductor in a second section of the circumferential line are arranged next to each other when viewed in said cross sectional plane.

In particular, the voice coil of the electrodynamic actuator is manufactured by a method as disclosed above.

The inventive problem additionally is solved by a speaker, which comprises an electrodynamic actuator of the above kind and a membrane, which is fixed to the voice coil and to the magnet system.

Further on, the inventive problem is solved by an electrodynamic (acoustic) transducer, which comprises a plate like structure with a sound emanating surface and a backside opposite to the sound emanating surface and which comprises an electrodynamic actuator of the above kind being connected to said backside. Beneficially, the at least one voice coil or the magnet system of the electrodynamic actuator comprises a flat mounting surface, which is intended to be connected to the backside of the plate like structure opposite to the sound emanating surface of the plate like structure, wherein said backside is oriented perpendicularly to the coil axis. In particular, the plate like structure can be embodied as a display. In this way, the electrodynamic actuator together with the display forms an output device (for both audio and video data).

Generally, in the first section more different windings can be arranged one above the other than in the second section, and in the second section more different windings can be arranged next to each other than in the first section when viewed in said cross sectional plane perpendicular to the circumferential line and when the coil axis indicates a height direction.

By means of the proposed measures, voice coils with varying height profiles can be manufactured, and the voice coils can have recesses like cutouts and holes. In this way, dealing with problematic space and design restrictions is eased. A particular output power and a particular sound quality can also be achieved under problematic space and design restrictions. In particular, the proposed measures provide the advantage that parts of the electrodynamic actuator itself or parts of the device, which the electrodynamic actuator is built into, may locally reach into the moving range of the voice coil. In this way, generally component density of electrodynamic actuators as such as well as of devices, which the electrodynamic actuators are built into, can be increased compared to prior art.

The proposed measures in particular apply to “micro” electrodynamic actuators. The proposed measures also apply to speakers in general and particularly to micro speakers, whose membrane area is smaller than 600 mm² and/or whose back volume is in a range from 200 mm³ to 2 cm³. Such micro speakers are used in all kinds of mobile devices such as mobile phones, mobile music devices, laptops and/or in headphones. It should be noted at this point that a micro speaker does not necessarily comprise its own back volume but can use a space of a device, which the speaker is built into, as a back volume. That means, the speaker does not necessarily comprise its own (closed) housing but can comprise just an (open) frame. The back volume of the devices, which such speakers are built into, typically is smaller than 10 cm³.

Generally an “electrodynamic actuator” transforms electrical power into movement and force. An electrodynamic actuator together with a membrane forms a “speaker”. An electrodynamic actuator together with a plate forms an “electrodynamic (acoustic) transducer”. A special embodiment of a plate is a display. In this case, an electrodynamic actuator together with a display forms an “output device” (for both audio and video data). Generally, a speaker, an electrodynamic transducer and an output device transform electrical power into sound.

It should be noted that sound can also emanate from the backside of the plate like structure and the membrane. However, this backside usually faces an interior space of a device (e.g. a mobile phone), which the speaker or output device is built into. Hence, the plate like structure or membrane may be considered to have the main sound emanating surface and a secondary sound emanating surface (i.e. said backside). Sound waves emanated by the main sound emanating surface directly reach the user's ear, whereas sound waves emanated by the secondary sound emanating surface do not directly reach the user's ear, but only indirectly via reflection or excitation of other surfaces of a housing the device, which the speaker or output device is built into.

The electrodynamic acoustic transducer may comprise a frame and/or a housing. The magnet system and/or the voice coil may be connected to or may be part of a housing or frame.

A “frame” commonly is a part, which holds together the membrane, the voice coil and the magnet system. Usually, the frame is directly connected to the membrane and the magnet system (e.g. by means of an adhesive), whereas the voice coil is connected to the membrane. Hence, the frame is fixedly arranged in relation to the magnet system. Normally, the frame together with the membrane, the voice coil and the magnet system form a sub system, which is the result of an intermediate step in a production process.

A “housing” normally is mounted to the frame and/or to the membrane and encompasses the back volume of a transducer, i.e. an air or gas compartment behind the membrane. Hence, the housing is fixedly arranged in relation to the magnet system. In common designs, the housing can be hermetically sealed respectively airtight. However, it may also comprise small openings or bass tubes as the case may be. Inter alia by variation of the back volume respectively by provision of openings in the housing, the acoustic performance of the transducer can be influenced.

Beneficially, the first section or a plurality of first sections in total can involve at least 50% of the circumferential line and the second section or a plurality of second sections in total can involve 50% at most of the circumferential line. In particular, the first section or a plurality of first sections in total can involve at least 60% of the circumferential line and the second section or a plurality of second sections in total can involve 40% at most of the circumferential line. In yet another preferred embodiment, the first section or a plurality of first sections in total can involve at least 70% of the circumferential line and the second section or a plurality of second sections in total can involve 30% at most of the circumferential line. “In total” in the above context means “all sections together” if there are more than one at all. For example, there may be four first sections and four second sections. So, “in total” in this example means “all four first sections together” and “all four second sections together”. In another preferred embodiment, a single first section involves at least 20% of the circumferential line and a single second section involves 20% at most of the circumferential line. In yet another preferred embodiment, a single first section involves at least 40% of the circumferential line and a single second section involves 40% at most of the circumferential line. In summary, the first section usually is larger than the second section (or at least equals the second section) what contributes to a uniform generation of the Lorentz force and hence to a uniform movement of the voice coil with low rocking tendency. This is particularly true if it is not possible to distribute the first and second section uniformly or symmetrically along the circumferential line.

Generally, the electrical conductor can have a circular cross section or a rectangular cross section. Beneficially, a diameter of the electrical conductor of the voice coil of “micro” electrodynamic actuators is ≤110 μm. The electrical conductor can also comprise a (electrically insulating) coating on the metal core as the case may be.

The electrical conductor of the voice coil can be made up of copper, aluminum, and any copper alloy or aluminum alloy for example.

Generally, said windings can be formed by winding the electrical conductor. In this case, a wire is wound, wherein different windings are arranged over one another but offset sideways to each other in the second section in a first step as defined hereinbefore.

In another advantageous embodiment, the windings can be formed by cutting, stamping or etching a metal sheet or metal foil and can be inter-connected by welding or soldering and/or folded on top of one another.

It should be noted that folding the electrical conductor on top of one another is different to winding an electrical conductor. “Folding on top of one another” in the above context means bending the (flat) electrical conductor by 180° so that again a flat structure is formed. “Winding” means bending an electrical conductor continuously so that a round coil is formed or making ongoing bends of <180° in the same direction so that a polygonal coil is formed. Generally, folding the electrical conductor may be done by hand, by machine or by a combination of both. It should also be noted that “folding on top of one another” in the above context shall not confused with the foldings in steps b) and c) where “folding” usually involves or means a bending angle of around 90°.

In particular, the method of manufacturing a voice coil may comprise the steps of:
i) cutting the electrical conductor out of a metallic foil;
ii) forming an insulation layer on the electrical conductor;
iii) making a stack of windings from the electrical conductor by stacking of separate windings (separate pieces of the electrical conductor) and electrically connecting the stacked separate windings and/or
folding of the electrical conductor;
iv) applying an adhesive between the windings of the stack and
v) forming the windings in the second section or in the second sections according to the process steps of any one of cases a) to c).

By means of the above measures, voice coils with nearly any shape can be manufactured by cutting out a corresponding piece of a metallic foil. In particular, very sharp corners can be made in case of polygonal structures. In contrast, this is not possible when a wire or foil is wound to form a polygonal coil because a comparably large radius is needed in each corner. Since the design of the magnet system goes hand in hand with the design of the voice coil, the proposed measures also substantially increase the possibilities to make a magnet system. This is of particular advantage if a polygonal magnet system is built up from a number of singular, linear magnets because on the ground of the sharp corner radius, substantially the whole length of the electrical conductor of the voice coil is flown trough by the magnetic field lines. That means that the sound pressure level in relation to the current flowing through the voice coil is very high, in other words the efficiency of the electrodynamic acoustic transducer, is very high. In addition, those voice coils can be produced with very low tolerances so that the air gap between the magnet system and the voice coil can be made very small. Accordingly, efficiency of the electrodynamic actuator is improved even more.

In addition, the proposed method provides voice coils with a high density of the electrical conductor. Preferably, a fill factor, which is the share of all windings or conductive layers on the volume of the voice coil is >80%. Other solutions, like voice coils with a coil wire provide a fill factor, which is much lower, thus downgrading the power weight ratio of a voice coil. In other words, the proposed electrodynamic actuator offers more sound power at the same weight in this embodiment. In addition, low weight of the voice coil does also substantially influence the sound quality of the electrodynamic acoustic transducer.

The metal foil used for the electrical conductor of the voice coil can be made up of copper, aluminum, and any copper alloy or aluminum alloy for example. Preferably, the thickness of a conductive layer is 10-30 μm. In this way, a desired number of turns can be provided within a desired height of the voice coil. The thickness of an insulation layer preferably is 1-5 μm. In this way, electric strength is high enough to withstand a voltage difference between the conductive layers, and the mechanical stability is high enough to withstand the forces applied to the voice coil during use, both without substantially decreasing the favorable power weight ratio of the voice coil. From the perspective of this point in time, a metal seems to be most useful for the production of voice coils. However, the proposed method applies to conductive foils in general. So, the term “metal foil” may mentally be replaced by the term “conductive foil” throughout this text, if a material different to a metal, but with comparable or better conductivity is provided.

It should be noted that steps i) to v) do not necessarily imply a particular sequence of production steps. For example, step ii) may implicitly take place when the conductive layers are connected to each other by means of an adhesive without the need of forming an insulation layer on the electrical conductor in a separate step. It should also be noted that mechanically connecting the conductive layers to each other by means of an adhesive in step iv) does not necessarily follow the step of electrically connecting the stacked separate windings in step iii), but the electrical connection can follow the mechanical connection. In this context it should also be noted that a mechanical connection means a substantial connection of the windings or conductive layers, in particular on an area of >50% of the area between two windings or conductive layers. Strictly speaking, an electrical connection is also a mechanical connection, but it usually does not substantially enhance the stability of the layer construct. Step v) (forming the windings in the second section or in the second sections according to the process steps of any one of cases a) to c)) may relate to forming single windings of a plurality of windings in sequence or to forming of a plurality of windings in one step. In a very advantageous embodiment, forming of a plurality of windings in one step is performed after steps i) to iv). In particular, step v) may take place by means of a mold. For example, the stack of windings is put into the mold after the adhesive has been applied and then two parts of the mold are pressed relative to each other to give the stack of windings the intended shape. In other words, the mold has a negative form of the voice coil. Application of the adhesive may also be done by simply flooding the mold with the adhesive and pressing out the superfluous part. However, forming the stack of windings may also be done between two press plates.

It should also be noted that stacking of separate windings and electrically connecting the stacked separate windings as well as folding of the electrical conductor to make a stack of conductive layers from the electrical conductor can be used in any desired combination. Thus, a stack of windings or conductive layers can be built up only by unfolded separate pieces of the electrical conductor, only by folded separate pieces of the electrical conductor (or even by just one folded piece) and in a mixed fashion by unfolded and folded separate pieces of the electrical conductor.

A “conductive layer” is a flat winding and hence a layer of the voice coil which is able to conduct a substantial level of an electric current. In this invention, a conductive layer is made from metal. It should be noted at this point that a “stack of conductive layers” does not exclude the existence of other layers between conductive layers, what in particular refers to “insulation layers”, “passivation layers” and/or “adhesive layers”.

An “insulation layer” is a layer of the voice coil which withstands a substantial level of a voltage and is not able to conduct a substantial level of an electric current. Examples for materials, which can be used to build up an insulation layer, are plastic materials, ceramics and oxides. An insulation layer can comprise a layer of a single insulating material, layers of different insulating materials, like the materials mentioned before, or a layer or more layers comprising a mixture of materials.

A “passivation layer” is a protective layer on the conductive layer. It may be generated by oxidation of the metal of the conductive layer. Accordingly, a passivation layer can comprise metal oxides. Usually, passivation layers have insulating characteristics. In this case, a passivation layer is part of the insulation layer. The generation of a passivation layer is optional, and the insulation layer may also be built up without a passivation layer.

An “adhesive layer” is a layer, which mechanically connects two adjacent layers by adhesion. An adhesive layer usually has insulating characteristics, too. In this case, an adhesive layer is also part of the insulation layer. So, an insulation layer generally may comprise a passivation layer and/or an adhesive layer. An adhesive layer can be made of glue (in particular liquid glue), of a which is applied onto a conductive layer or onto a passivation layer on a conductive layer, for example by spraying, pad printing or rolling. Liquid glue may also be applied into a gap between two conductive layers or passivation layers. This glue is then sucked into the gap by means of capillary action. Liquid glue may comprise anaerobic or heat curing adhesives, 2-component adhesives and hotmelt adhesives (e.g., epoxy, acrylic). The viscosity of the adhesive can be less than 1000 mPas. In some embodiments, the viscosity of the adhesive is less than 500 mPas or even less than 50 mPas. An adhesive layer may also be formed by a plastic foil, in particular by a single sided or double sided adhesive foil or by a thermoset adhesive film or a hotmelt adhesive film, which is applied onto a conductive layer or onto a passivation layer.

“Cutting” the electrical conductor out of a metallic foil may happen in a number of ways. For example, a laser, a water jet, plasma cutting, photo etching, a knife or punching may be used for performing the cutting step. Furthermore, the metallic foil can be cut piece by piece, or a number of layers is cut in a single step. In the latter case, the layers may be interconnected (mechanically and/or electrically) or not. Accordingly, other layers than conductive layers, in particular insulation layers, passivation layers and/or adhesive layers may be cut at the same point in time.

Further advantageous embodiments are disclosed in the claims and in the description as well as in the figures.

In a beneficial embodiment, the electrical conductor is made up from or comprises aluminum and is hardened and annealed in the region of a folding or bending. Folds in the electrical conductor can lead to an increased electrical resistance in the region of the folds what can impact the acoustic performance of the electrodynamic actuator. This resistance increase may be compensated by increasing the width of the electrical conductor in the region of the folding lines. In turn, a larger cross-sectional area for the electrical current to flow through is provided, which thus reduces the electrical resistance. However, if aluminum is used for the electrical conductor, it may be hardened and locally annealed in the region of the folds what reduces the electrical resistance as well. In this way, the width of the electrical conductor in the region of the folding lines does not need to be increased as there is little to no increase of the resistance as a result of the folding. A laser and in particular the same laser, which is used for cutting and/or welding, can be used to harden and anneal the electrical conductor in the region of the bending.

In another advantageous embodiment, the first winding of said windings performs a lateral movement (or there is at least a lateral movement component) transverse to the coil axis in the second section during one of the steps a) to c).

In particular,
the first winding of said windings can protrude outwards away from the coil axis before performing one of the steps a) to c) and can perform an inward lateral movement transverse to the coil axis in the second section during said one of the steps a) to c) or
the first winding of said windings can protrude inwards to the coil axis before performing one of the steps a) to c) and can perform an outward lateral movement transverse to the coil axis in the second section during said one of the steps a) to c).

Generally, the protrusions help to avoid or at least limit stretching the first winding in the second section because the first winding is longer than the second winding there before deformation. In particular, the length of the first winding in the second section in the unbent state may equal its length in the bent state.

In yet another embodiment, all windings in the first section of the circumferential line can be arranged one above the other when viewed in said cross sectional plane perpendicular to the circumferential line and when the coil axis indicates a height direction. In this way, a voice coil is obtained which looks like a single layer coil in the first section.

Beneficially,
a first part of the windings in the second section of the circumferential line can be arranged next to each other when viewed in said cross sectional plane perpendicular to the circumferential line and
a remaining second part of the windings in the second section of the circumferential line can be arranged on top of one another when viewed in said cross sectional plane.

In this way, shallow recesses or recesses with low height compared to the total height of the voice coil can be manufactured.

Advantageously, a virtual line, which is arranged in said cross sectional plane perpendicular to the circumferential line and which is oriented perpendicular to the coil axis, indicates a width direction, wherein a width of the conductor is the same in the first section and in the second section. In this way, a uniform conductivity of the electrical conductor along the circumferential line can be obtained. The voice coil is broader in the second section than in the first section in this case.

Advantageously, said virtual line indicates a width direction, wherein a width of the conductor in the first section is larger than that a width of the conductor in the second section. In this way, the width of the conductor is reduced in the second section to reduce the overall width of the voice coil in the second section.

In a very advantageous embodiment, said virtual line indicates a width direction, wherein a total width of the windings is the same in the first section and in the second section. In this way the width of the voice coil is the same in first and second section. In other words, a voice coil with uniform width along the circumferential line is obtained in this embodiment.

In one embodiment, exactly two windings of said windings are arranged next to each other at a particular height level in the second section. In that way, manufacturing of the voice coil in the second section does not get very complicated. In another embodiment, more than two windings of said windings are arranged next to each other at a particular height level in the second section. In this way, deep recesses can be made in the voice coil.

Beneficially, an average sound pressure level of the speaker or the electrodynamic transducer (or the output device) measured in an orthogonal distance of 10 cm from the sound emanating surface is at least 50 dB_SPL in a frequency range from 100 Hz to 15 kHz. “Average sound pressure level SPL_{AVG}” in general means the integral of the sound pressure level SPL over a particular frequency range divided by said frequency range. In the above context, in detail the ratio between the sound pressure level SPL integrated over a frequency range from f=100 Hz to f=15 kHz and the frequency range from f=100 Hz to f=15 kHz is meant. In particular, the above average sound pressure level is measured at 1 W electrical power more particularly at the nominal impedance. The unit “dB_SPL” generally denotes the sound pressure level relative to the threshold of audibility, which is 20 μPa.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows an angular view of a voice coil with a recess;

FIG. 2 shows a cross section through a voice coil in the first section;

FIG. 3 shows a cross section through a voice coil in the second section;

FIG. 4 shows two windings of the voice coil in the second section in unbent state in detailed angular view from below;

FIG. 5 shows the two windings of FIG. 4 in bent state;

FIG. 6 shows a bottom view of the two windings of FIG. 5 with an additional pressing tool;

FIG. 7 shows the first winding of FIGS. 4 to 6 in top view;

FIG. 8 shows the second winding of FIGS. 4 to 6 in top view;

FIG. 9 is similar to FIG. 4 but with the second winding protruding outwards in the unbent state;

FIG. 10 shows the first winding of FIG. 9 in top view;

FIG. 11 shows the second winding of FIG. 9 in top view;

FIG. 12 shows a number of windings being welded by a laser beam to form a voice coil in angular view;

FIG. 13 shows a top view of an electrical conductor before it is bent along folding lines to form a voice coil;

FIG. 14 shows how pressing a stack of windings may take place by means of a mold;

FIG. 15 shows how pressing a stack of windings may take place by means of pressing plates;

FIG. 16 shows how the stack of windings may look like after the pressing step according to a first embodiment;

FIG. 17 shows how the stack of windings may look like after the pressing step according to a second embodiment;

FIG. 18 shows an angular view of a voice coil with a hole-like recess;

FIG. 19 shows an example of a speaker with an electromagnetic actuator having a voice coil of the disclosed kind in exploded view;

FIG. 20 shows the speaker of FIG. 19 in cross sectional view;

FIG. 21 shows the voice coil, the arm arrangement and the frame of the speaker of FIG. 19 in angular view from below;

FIG. 22 shows a cross sectional view of a first example of an electrodynamic transducer and

FIG. 23 shows a cross sectional view of a second example of an electrodynamic transducer with a movable and a fixed part of the magnet system.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

All directional references (e.g., “plus”, “minus”, “upper”, “lower”, “upward”, “downward”, “left”, “right”, “leftward”, “rightward”, “front”, “rear”, “top”, “bottom”, “over”, “under”, “above”, “below”, “vertical”, “horizontal”, “clockwise”, and “counterclockwise”) are only used for identification purposes to aid the reader's understanding of the present disclosure, and do not create limitations, particularly as to the position, orientation, or use of the any aspect of the disclosure. It is to be understood that the terms so used are interchangeable under appropriate circumstances such that the embodiments of the invention described herein are, for example, capable of operation in other orientations than those illustrated or otherwise described herein.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose.

Joinder references (e.g., “attached”, “coupled”, “connected”, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

All numbers expressing measurements and so forth used in the specification and claims are to be understood as being modified in all instances by the term “about” or “substantially”, which particularly means a deviation of ±10% from a reference value.

FIG. 1 shows an angular view of a voice coil 1a, which has an electrical conductor in the shape of loops or windings running around a coil axis A along a circumferential line C in a loop section. Different windings of the electrical conductor are arranged one above the other in a first section B1 of the circumferential line C when viewed in a cross sectional plane D perpendicular to the circumferential line C, wherein the coil axis A indicates a height direction. Further on, said different windings of the electrical conductor are arranged next to each other in a second section B2 of the circumferential line C when viewed in said cross sectional plane D. In the first section B1 of the circumferential line C, the voice coil 1a has a standard-height section 2, and in the second section B2 of the circumferential line C, the voice coil 1a has a recess 3a.

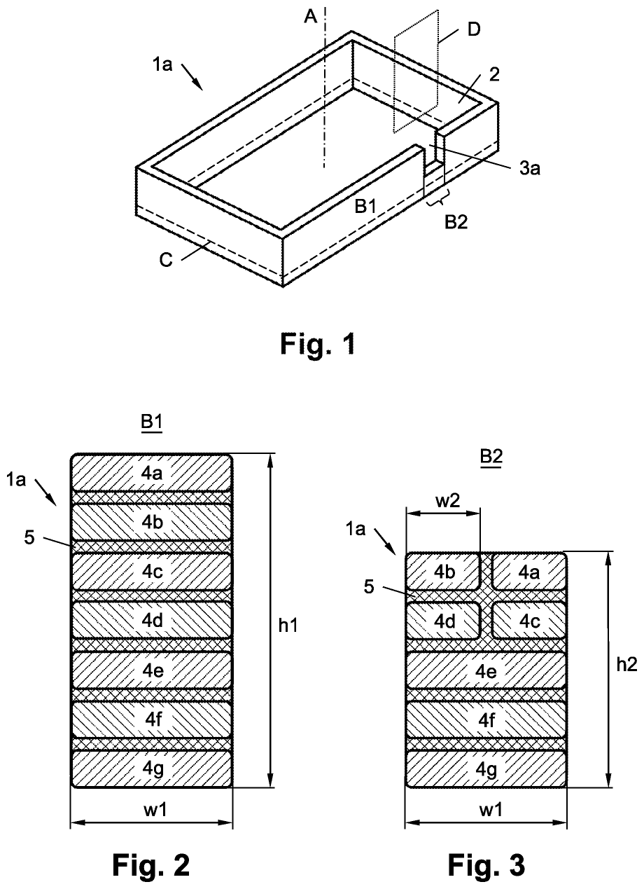

FIGS. 2 and 3 show the arrangement of the electrical conductor in more detail. Concretely, FIG. 2 shows a cross section through the voice coil 1a in the first section B1 of the circumferential line C, and FIG. 3 shows a cross section through the voice coil 1a in the second section B2 of the circumferential line C. Both cross sectional planes are perpendicular to the circumferential line C in the section B1, B2 of question.

The voice coil 1a in this example has seven windings 4a . . . 4g, which are all arranged one above the other in the first section B1 as shown in FIG. 2. In the second section B2, some of the windings 4a . . . 4g are arranged next to each other. In detail, the windings 4a . . . 4d, which are arranged one above the other in the first section B1, are arranged in two planes in the second section B2. In more detail, the winding 4b is arranged next to the winding 4a, and the winding 4d is arranged next to the winding 4c. In this way, a height h1 of the voice coil 1a in the first section B1 is greater than a height h2 of the voice coil 1a in the second section B2, wherein the coil axis A indicates a height direction. Accordingly, the recess 3a may be formed in the voice coil 1a by this arrangement of windings 4a . . . 4g.

Between the windings 4a . . . 4g there is an insulating adhesive 5, by means of which first, the windings 4a . . . 4g are fixed to each other to improve the mechanical stability of the voice coil 1a and second, by means of which the windings 4a . . . 4g are insulated from each other, so that a current has to flow through the electrical conductor in loops.

The voice coil 1a has some more special characteristics:

In the first section B1 more different windings 4a . . . 4g are arranged one above the other than in the second section B2 and that in the second section B2 more different windings 4a . . . 4g are arranged next to each other than in the first section B1 when viewed in said cross sectional plane D perpendicular to the circumferential line C and when the coil axis A indicates a height direction (accordingly, the recess 3a is formed in the voice coil 1a).

All windings 4a . . . 4g in the first section B1 of the circumferential line C are arranged one above the other when viewed in said cross sectional plane D perpendicular to the circumferential line C and when the coil axis A indicates a height direction (accordingly, a single layer coil is formed in the first section B1).

A first part of the windings 4a . . . 4g in the second section B2 of the circumferential line C is arranged next to each other when viewed in said cross sectional plane D perpendicular to the circumferential line C and a remaining second part of the windings 4a . . . 4g in the second section B2 of the circumferential line C is arranged on top of one another when viewed in said cross sectional plane D (accordingly, the recess 3a is less deep than it could be when all windings 4a . . . 4g were arranged next to each other in the second section B2).

Exactly two windings 4a, 4a′, 4b of said windings 4a . . . 4g are arranged next to each other at a particular height level (accordingly, manufacturing the voice coil 1a in the second section B2 is eased).

A width w1 of the conductor in the first section B1 is larger than that a width w2 of the conductor in the second section B2, wherein a virtual line, which is arranged in said cross sectional plane D perpendicular to the circumferential line C and which is oriented perpendicular to the coil axis A, indicates a width direction (accordingly, the width w2 of the electrical conductor in the second section B2 is reduced in view of its width w1 in the first section B1 so as to reduce the overall width of the voice coil 1a in the second section B2).

A total width w1 of the windings 4a . . . 4g is the same in the first section B1 and in the second section B2 (accordingly, the voice coil 1a has equal coil width in first and second section B1, B2).

The electrical conductor has a rectangular cross section.

One should note that the above characteristics and their combination is not mandatory but voice coils 1a may differ from the above characteristics and their combination.

For example:

Windings 4a . . . 4g in the first section B1 can be arranged next to each other when viewed in said cross sectional plane D so as to form a multi-layer coil in the first section B1.

Each of the windings 4a . . . 4g in the second section B2 can have an adjacent winding 4a . . . 4g, which is arranged next to said winding 4a . . . 4g at a particular height level so that the recess 3a can be very deep.

More than two windings of said windings 4a . . . 4g can be arranged next to each other at a particular height level in the second section B2 so that the recess 3a can be made even deeper.

The width w1, w2 of the electrical conductor can be the same in the first section B1 and in the second section B2 so that the cross section of the electrical conductor is not reduced in the second section B2. Accordingly, the electrical resistance of the electrical conductor is not increased in the second section B2 either.

The total width w1 of the windings 4a . . . 4g can be different in the first section B1 and in the second section B2.

The electrical conductor can have a different cross section, for example a circular cross section.

Generally, it is of advantage if the first section B1 or a plurality of first sections B1 in total involves at least 50% of the circumferential line C and the second section B2 or a plurality of second sections B2 in total involves 50% at most of the circumferential line C. In particular, the first section B1 or a plurality of first sections B1 in total can involve at least 60% of the circumferential line C and the second section B2 or a plurality of second sections B2 in total can involve 40% at most of the circumferential line C. In yet another preferred embodiment, the first section B1 or a plurality of first sections B1 in total can involve at least 70% of the circumferential line C and the second section B2 or a plurality of second sections B2 in total can involve 30% at most of the circumferential line C. In another preferred embodiment, a single first section B1 involves at least 20% of the circumferential line C and a single second section B2 involves 20% at most of the circumferential line C. In yet another preferred embodiment, a single first section B1 involves at least 40% of the circumferential line C and a single second section B2 involves 40% at most of the circumferential line C. The above measures contribute to a proper function of the voice coil 1a because the second section B2 is kept small in relation the first section B1, and accordingly the overall resistance of the voice coil 1a is kept low, and uniform operation in terms of coil movement is provided.

Generally, the second section B2 may be formed by arranging a first and a second winding 4a, 4b of the windings 4a . . . 4g over one another but offset sideways to each other in the second section B2 in a first step, and by pressing a first winding 4a into a height position of a second winding 4b in the second section B2 in a second step (case a).

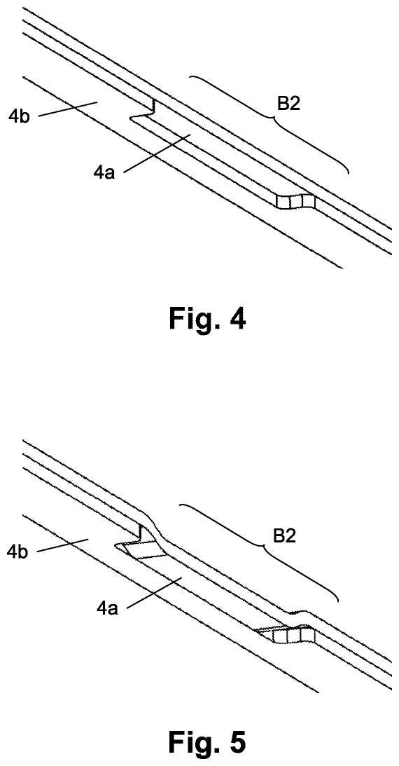

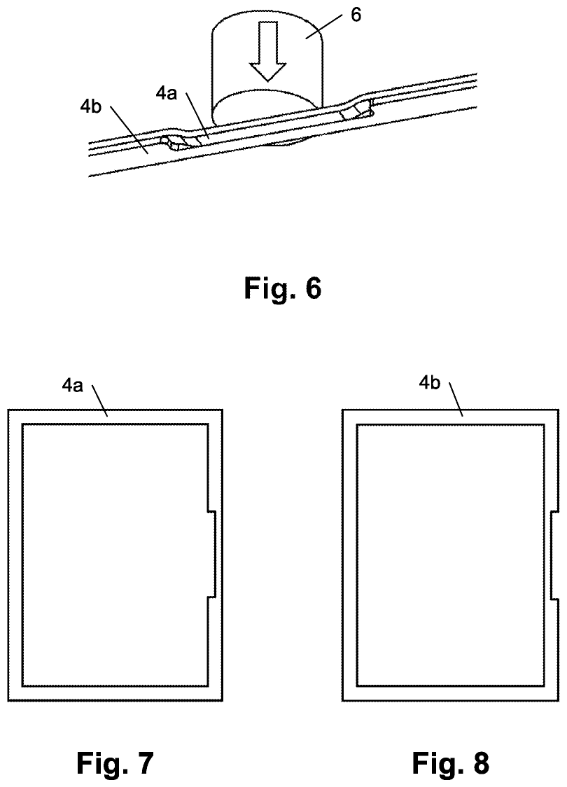

In this context, FIGS. 4 to 6 show two windings 4a, 4b of the windings 4a . . . 4g in different states and in angular view from below. In addition, FIGS. 7 and 8 show the windings 4a, 4b in top view. As can be seen, the second winding 4b in the second section B2 has a cutout and is smaller there than in the first section B1. So does the first winding 4a, but its cutout is arranged mirror-inverted in view of the cutout of the second winding 4b (in particular see FIGS. 7 and 8). FIG. 4 shows the arrangement in the first step, in which the windings 4a, 4b are arranged over one another but offset sideways to each other in the second section B2. FIG. 5 shows the arrangement after the second step in a state, in which the first winding 4a has been pressed into a height position of the second winding 4b in the second section B2. FIG. 6 depicts an example, in which this second step is performed by a tool 6 (e.g. a press ram), which is pressed onto the first winding 4a and deforms the same in the second section B2.

As a result, the first winding 4a and the second winding 4b are located at the same height position or in the same plane being arranged perpendicular to the coil axis A when viewed in a cross sectional plane including the coil axis A after this pressing step.

Although pressing the first winding 4a into a height position of the second winding 4b is an advantageous method of forming the voice coil 1a in the second section B2, this is not the only possibility. The voice coil 1a in the second section B2 may also be formed by folding a first winding 4a′ into a height position of a second winding 4b (case b).

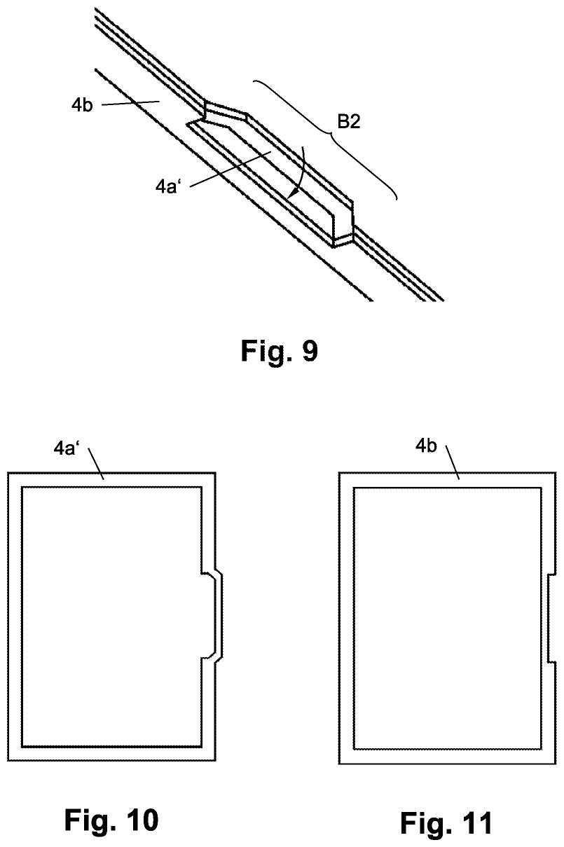

In this context, FIG. 9 shows two windings 4a′, 4b of the windings 4a . . . 4g in the first state and in angular view from below. In addition, FIGS. 10 and 11 show the windings 4a′, 4b in top view. As can be seen, the second winding 4b in the second section B2 again has a cutout and is smaller there than in the first section B1. So does the first winding 4a′, but its cutout is not just arranged mirror-inverted in view of the cutout of the second winding 4b but in contrast to the embodiment shown in FIGS. 4 to 8 protrudes outwards away from the coil axis A. In the second step, the first winding 4a′ is folded into the height position of the second winding 4b. That means that the first winding 4a′ performs a rotational movement in the second section B2 (see arrow in FIG. 9). In other words, it is twisted there.

Accordingly, the first winding 4a′ performs a lateral movement transverse to the coil axis A in the second section B2 during the second step. In more detail, the first winding 4a′ also performs a vertical movement. Hence, the movement of the first winding 4a′ has a lateral movement component and a vertical movement component. Concretely, it performs an inward lateral movement transverse to the coil axis A in the second section B2 during the folding step.

As a result, the first winding 4a′ and the second winding 4b are located at the same height position or in the same plane being arranged perpendicular to the coil axis A when viewed in a cross sectional plane including the coil axis A after this folding step.

In the embodiment shown in FIGS. 9 to 11, the first winding 4a′ protrudes outwards away from the coil axis A before performing the folding step and performs an inward lateral movement transverse to the coil axis A during the folding step. Alternatively, the first winding 4a′ can also protrude inwards to the coil axis A before performing the folding step and perform an outward lateral movement transverse to the coil axis A during the folding step.

The shape of the first winding 4a′ shown in FIGS. 9 to 11 is not limited to be folded, but it can also be pressed vertically and then laterally, laterally and then vertically or in a direction having a combined lateral and vertical component. In this variant there is no folding movement but just a translational deformation.

Third, generally a combined folding and pressing movement of the first winding 4a, 4a′ is possible in the second step so that the first winding 4a, 4a′ moves into the height position of the second winding 4b (case c).

In all cases (folding and/or pressing) the protrusions of the first winding 4a′ help to avoid or at least limit stretching the first winding 4a′ in the second section B2 because the first winding 4a′ is longer than the second winding 4b there. In particular, the length of the first winding 4a′ in the second section B2 in the unbent state may equal its length in the bent state.

It should also be noted that a pressing movement is not necessarily performed by a stamp-like tool 6 as depicted in FIG. 6, but deformation of the first winding 4a, 4a′ may also be done by a pulling movement with kind of a hook. However, in the context of this disclosure, such a pulling movement is considered as a pressing movement for the first winding 4a, 4a′ because a compressive force acts between the first winding 4a, 4a′ and the hook then and not a tension force.

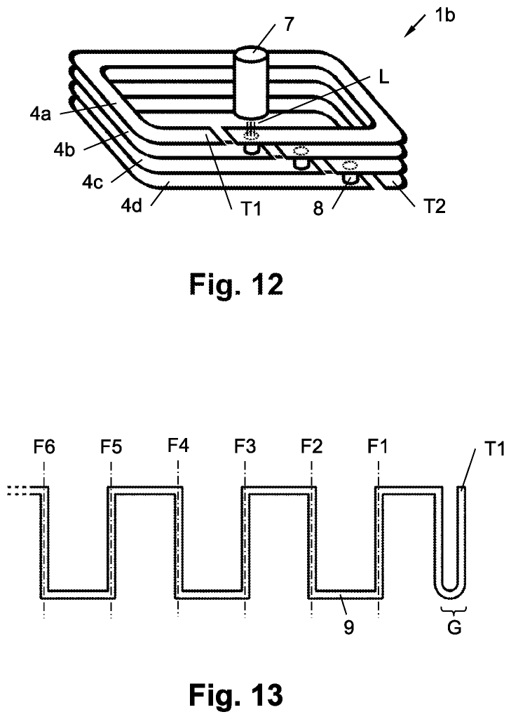

In the examples shown in FIGS. 4 to 11, the windings 4a . . . 4g preferably are formed by cutting, stamping or etching a metal sheet or metal foil. In particular, laser cutting may be used for that process step. In a first embodiment, the single windings 4a . . . 4g can be interconnected by welding or soldering like this is illustrated in FIG. 12, wherein just four windings 4a . . . 4d are interconnected in this example. In particular, laser welding or ultrasonic welding may be used for this task.

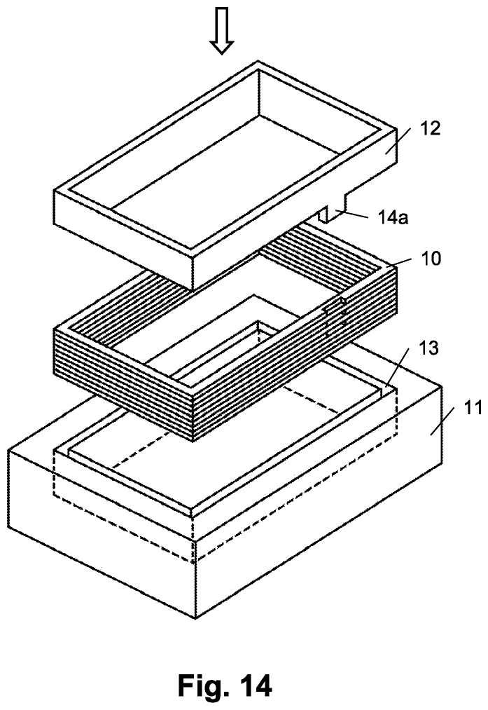

In detail, FIG. 12 shows four windings 4a . . . 4d, which are welded by the laser beam L of a laser 7. In this way, joints 8 are formed so that the electrical conductor made up from the four windings 4a . . . 4d and the joints 8 has a semi-helical shape. At the ends of the electrical conductor there are two terminals T1, T2 which are meant for connecting the voice coil 1b to an amplifier of an audio signal source. It should be noted that FIG. 12 is intended to show the welding process, and the voice coil 1b there has no recess 3a for the sake of simplicity. Alternatively, the electrical conductor can be considered as a stack of windings 4a . . . 4g, in which a recess 3a is formed later (see FIGS. 14 to 17 in this context).

In another embodiment, the electrical conductor 9 in an initial state has a shape which easiest can be explained as a shape like a square signal. It can be formed by bending an initially straight electrical conductor 9 or again by cutting, stamping or etching a metal sheet or metal foil. In a next step the pre-windings formed by the electrical conductor 9 are folded on top of one another in a zig-zag way (or like a leporello) along the folding lines F1 . . . F6 like this is depicted in FIG. 13. In this way, again the electrical conductor 9 gets a semi-helical shape in the end. The electrical conductor 9 again has terminals, of which only the first terminal T1 is depicted in FIG. 13. Moreover, the electrical conductor 9 has an optional bow section G in this example, which allows a movement of the voice coil along the coil axis A when it is built into an electrodynamic actuator and when the first termina T1 is fixed.

In this context one should note that the terminals T1, T2 of the voice coil 1b are no fixed terminals but moving terminals and should be connected to flexible conductors when the voice coil 1b is built into an electrodynamic actuator. Alternatively, the first winding 4a and the last winding 4b may have extensions forming those flexible sections of the electrical conductor 9.

In the above examples, the windings 4a . . . 4g are formed by a comparably complex production method, which particularly allows manufacturing voice coils 1a, 1b of any desired shape (even with sharp corners). However, the windings 4a . . . 4g can also be formed by winding the electrical conductor 9.

It should be noted that the windings 4a . . . 4g in all examples can get a passivation or insulation layer so as to avoid short circuits between windings 4a . . . 4g. This passivation or insulation layer is applied before the windings 4a . . . 4g are interconnected by means of an insulating adhesive 5. If the passivation or insulation layer is strong enough, in principle the adhesive 5 does not need to have outstanding insulation capability. However, it is clear that insulation between windings 4a . . . 4g is achieved by both the passivation or insulation layer and the adhesive 5. So, proper insulation capability of the adhesive 5 improves the total insulation capability between the windings 4a . . . 4g.

In all embodiments the electrical conductor 9 can be made up from or comprise aluminum or copper. In case of aluminum, the electrical conductor 9 beneficially is hardened and annealed in the region of a folding or bending. Folds in the electrical conductor 9 can lead to an increased electrical resistance in the region of the folds what can impact the acoustic performance of the electrodynamic actuator. This resistance increase may be compensated by increasing the width of the electrical conductor 9 in the region of the folding lines F1 . . . F6. In turn, a larger cross-sectional area for the electrical current to flow through is provided, which thus reduces the electrical resistance. However, if aluminum is used for the electrical conductor, it may be hardened and locally annealed in the region of the folds what reduces the electrical resistance as well. In this way, the width of the electrical conductor 9 in the region of the folding lines F1 . . . F6 does not need to be increased as there is little to no increase of the resistance as a result of the folding. A laser 7 and in particular the same laser, which is used for cutting and/or welding, can be used to harden and anneal the electrical conductor 9 in the region of the bending.

As has already been noted, the examples of FIGS. 12 and 13 do not show the formation of a recess 3a in the voice coil 1a, 1b. In principle, this can be done by doing the steps as outlined in view of the examples shown in FIGS. 4 to 11 sequentially for a number of windings 4a . . . 4g and by forming then a voice coil 1a, 1b as outlined in the examples of FIGS. 12 and 13. However, in a more preferred embodiment, a stack of windings 4a . . . 4g is formed first, and then a plurality of windings 4a . . . 4g is deformed to form the recess 3a in a single process step. For example, the tool 6 can press a plurality of windings 4a . . . 4g into shape in a single process step.

In particular, a production method of a voice coil 1a, 1b can comprise the steps of:
i) cutting the electrical conductor 9 out of a metallic foil;
ii) forming an insulation layer on the electrical conductor 9;
iii) making a stack of windings 4a . . . 4g from the electrical conductor 9 by stacking of windings 4a . . . 4g (separate pieces of the electrical conductor 9) and electrically connecting the stacked separate windings 4a . . . 4g (see FIG. 12) and/or
folding of the electrical conductor 9 (see FIG. 13);
iv) applying an adhesive 5 between the windings 4a . . . 4g of the stack and
v) forming the windings 4a . . . 4g in the second section B2 or in the second sections B2 according to the process steps of any one of cases a) to c).

In particular, step v) may take place by means of a mold what is illustrated by means of FIG. 14. In detail, FIG. 14 shows a stack 10 of windings 4a . . . 4g, a lower mold part 11 and an upper mold part 12. Beneficially, the stack 10 of windings 4a . . . 4g is put into a groove 13 in the lower mold part 11 after the adhesive 5 has been applied, and then the two mold parts 11 and 12 are pressed relative to each other to give the stack 10 of windings 4a . . . 4g the intended shape. To form the recess 3a in the voice coil 1a, 1b, the upper mold part 12 has a protrusion 14a. In other words, the mold parts 11 and 12 have a negative form of the voice coil 1a, 1b. Application of the adhesive 5 may also be done by simply flooding the groove 13 in the lower mold part 11 with the adhesive 5 and pressing out the superfluous part with the upper mold part 12.

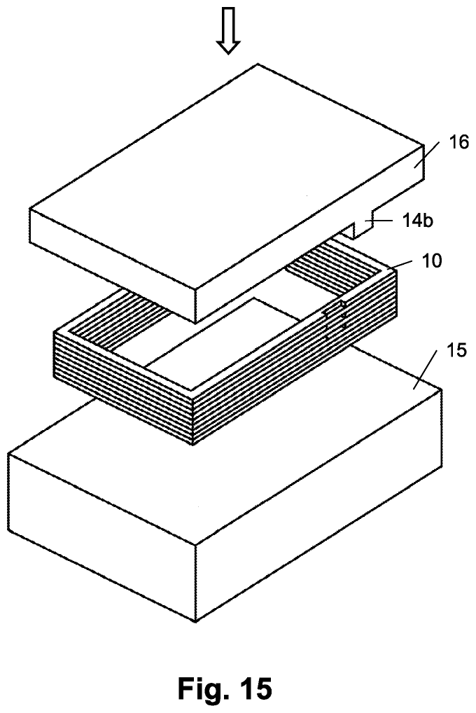

In another embodiment, which is illustrated in FIG. 15, the stack 10 of windings 4a . . . 4g is pressed between a lower press plate 15 and an upper press plate 16. Similarly to the above embodiment, it is beneficial if the stack 10 of windings 4a . . . 4g is put onto the lower press plate 15 after the adhesive 5 has been applied, and then two press plates 15 and 16 are pressed relative to each other to give the stack 10 of windings 4a . . . 4g the intended shape. To form the recess 3a in the voice coil 1a, 1b, the upper press plate 16 has a protrusion or ridge 14b.

In both embodiments illustrated by use of FIGS. 14 and 15 a plurality of windings 4a . . . 4g are formed in a single process step. Accordingly, voice coils 1a, 1b can be manufactured very efficiently there and in short time.

It should be noted that although in FIGS. 14 and 15 a linear pressing movement is shown (case a), it would also be possible to swivel or fold the first windings 4a′ of the stack 10 in the second section B2 as disclosed in the example illustrated by use of FIGS. 9 to 11 (case b) or to do a combined pressing and folding movement. It is also possible that the first windings 4a′ of the stack 10 are laterally bent in the second section B2 by a third part of the pressing tool (not shown in FIGS. 14 and 15).

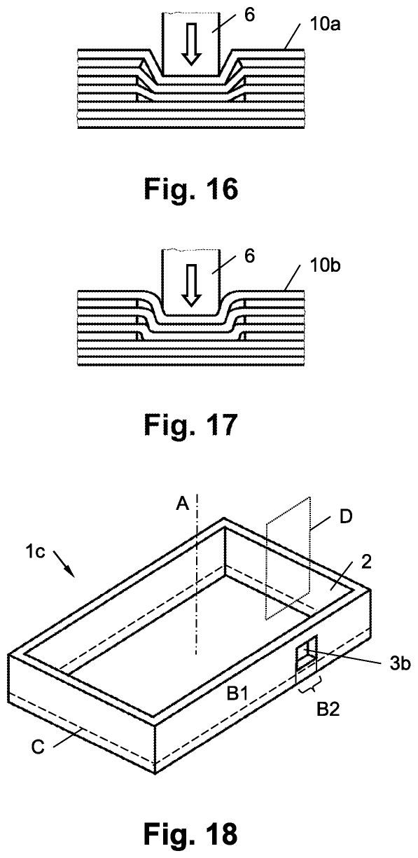

FIGS. 16 and 17 show the pressing step in more detail. Concretely, the stack 10a, 10b of windings 4a . . . 4g is shown after the pressing tool 6 has been moved downwards. Depending on the material, the windings 4a . . . 4g are rather deformed like in the stack 10a of FIG. 16 or rather like in the stack 10b of FIG. 17. Mixed deformations are possible as well of course.

FIG. 18 by way of a voice coil 1c shows, that the recess 3b is not necessarily a cutout or groove like this is the case for the recess 3a in FIG. 1, but the recess 3b can also have the shape of hole as well. In this case, there can be a pin-like or bar-like tool part, which is moved into the area of the recess 3b during the pressing step. It is also possible, to form two halves of a voice coil 1a first, which each has a recess 3a like shown in FIG. 1, and then to put them together to obtain a shape like shown in FIG. 18.

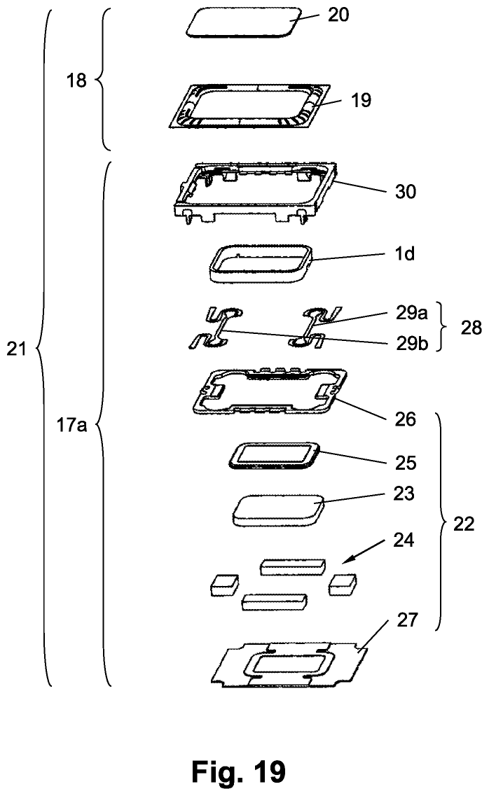

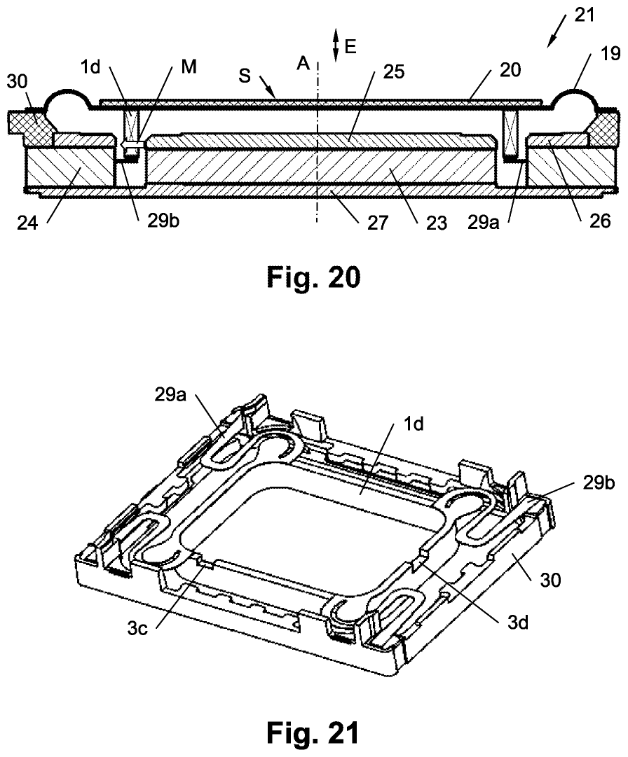

FIGS. 19 and 20 now show an example of an electrodynamic actuator 17a. FIG. 19 shows an exploded view of the electrodynamic actuator 17a and FIG. 20 shows a cross sectional view of the electromagnetic actuator 17a.

Generally, the electromagnetic actuator 17a is designed to be connected to a backside of a plate like structure or membrane opposite to a sound emanating surface S of the plate like structure or the membrane. In the example shown in FIGS. 19 and 20, the electromagnetic actuator 17a is connected to a backside of a membrane 18. The membrane 18 in this example comprises a flexible membrane part 19 and a rigid membrane part 20 in the shape of a plate. However, the rigid membrane part 19 is just optionally and may be omitted. The electromagnetic actuator 17a together with the membrane 18 forms a speaker 21. So, in principle, FIG. 19 shows an exploded view of the speaker 21 and FIG. 20 shows a cross sectional view of the speaker 21.

The electromagnetic actuator 17a comprises a voice coil 1d, which can be designed as is disclosed hereinbefore. The electromagnetic actuator 17a furthermore comprises a magnet system 22, which in this example comprises a center magnet 23 and outer magnets 24 as well as a center top plate 25 from soft iron, an outer top plate 26 from soft iron and a bottom plate 27 from soft iron. The center magnet 23 is mounted to the bottom plate 27 and to the center top plate 25, and the outer magnets 24 are mounted to the bottom plate 27 and to the outer top plate 26. The magnet system 22 generally is designed to generate a magnetic field M transverse to a longitudinal direction of the electrical conductor 9 of the voice coil 1d in a loop section.

Moreover, the electromagnetic actuator 17a comprises an arm arrangement 28, which generally comprises of a plurality of arms (or legs or levers) connecting the voice coil 1d and the magnet system 22 and which allows a relative movement between the voice coil 1d and said magnet system 22 in an excursion direction E parallel to the coil axis A. In this example, the arm arrangement 28 comprises two arm sub arrangements 29a, 29b each having two arms.

Finally, the electromagnetic actuator 17a comprises a frame 30, to which the membrane 18 (in detail its flexible membrane part 19), the outer magnets 24, the outer top plate 26 and the bottom plate 20 are mounted. However, the frame 30 may be shaped differently than depicted and may hold together a different set of parts. For example, it may be connected only to the outer magnets 24 or to the outer top plate 26. It should also be noted that the arm arrangement 28 does not necessarily connect the voice coil 1d and the magnet system 22 directly, but it may also connect them (indirectly) via the frame 30 for example.

FIG. 21 shows the voice coil 1d, the arm arrangement 28 and the frame 30 separated from the remaining parts of the speaker 21 in angular view from below. Moreover, FIG. 21 shows that the voice coil 1d has two recesses 3c, 3d in this embodiment in detail.

Generally, a voice coil 1a . . . 1d may have any number of recesses 3a . . . 3d of any desired shape. For example, the corners of a voice coil 1a . . . 1d may be raised, whereas the longitudinal sides may be lowered or vice versa. In addition, the recesses 3a . . . 3d may be longer or shorter, may have the shape of a rectangular depression or hole in sideview or may be shaped in another way. For example the recesses 3a . . . 3d may have the shape of a triangular or rounded depression or hole and the like in sideview.

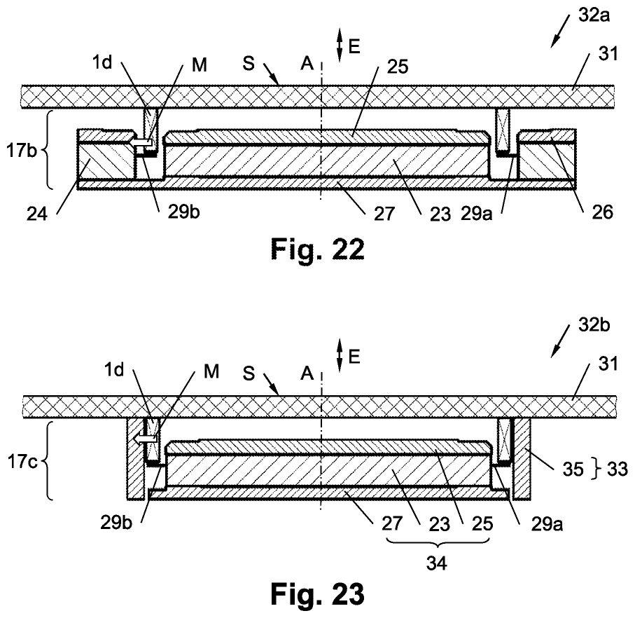

In the examples shown in FIGS. 19 to 21, the electromagnetic actuator 17a is connected to a membrane 18 thus forming a speaker 21. This however is no necessary condition, but an electromagnetic actuator 17b, 17c can also be connected to a plate like structure 31 like this is shown in FIGS. 22 and 23. In this way, electrodynamic transducers 32a, 32b are formed. In detail, the plate like structure 31 comprises a sound emanating surface S and a backside opposite to the sound emanating surface S. The electrodynamic actuator 17b, 17c is connected to its backside. For this reason, the voice coil 1d or the magnet system 22 comprises a flat mounting surface, which is intended to be connected to the backside of the plate like structure 31, wherein said backside is oriented perpendicularly to the coil axis A.

FIG. 22 shows a first example for such an electrodynamic transducers 32a. In fact, the electromagnetic actuator 17b looks very much like the electromagnetic actuator 17a, which is used for the speaker 21. In contrast, the magnet system 22 is not connected to the plate like structure 31, but it may freely move in relation to the voice coil 1d. In the example of FIG. 22 a frame 30 is omitted. Nonetheless, the electrodynamic transducer 32a can also comprise a frame 30 as the case may be.

FIG. 23 shows an example of an electrodynamic transducer 32b, which is similar to the electrodynamic transducer 32a of FIG. 22. The main difference is that the magnet system 22 comprises a fixed part 33 and a movable part 34. The fixed part 33 in this example is formed by an outer ring 35 from soft iron, and the movable part 34 is formed by the center magnet 23, the center top plate 25 and the bottom plate 27. Another difference is that the arm sub arrangements 29a, 29b are arranged on the inner side of the voice coil 1d and connect the same to the movable part 34 of the magnet system 22. Thus the movable part 34 may freely move relative to the voice coil 1d.

In general, as said, an electromagnetic actuator 17b, 17c together with the plate like structure 31 forms an electrodynamic transducer 32a, 32b. For example, the plate like structure can be a passive structure, for example a part of a housing of a device, which the electromagnetic actuator 17b, 17c is built into. However, the plate like structure can also have a special function itself. For example, if the plate like structure 31 is embodied as a display, the electrodynamic actuator 17b, 17c together with the display forms an output device (for both audio and video data).

In contrast to a membrane 18, a plate like structure 31 in the sense of this disclosure has no dedicated flexible part like the membrane 18 has. Accordingly, there is no extreme separation of deflection and piston movement like it is the case for the flexible membrane part 19 (deflection) and a rigid membrane part 20 (piston movement). Instead, sound generation is done via deflection of the whole plate like structure 31. When a plate like structure 31 is used, moreover either the voice coil 1d or the magnet system 22 (or at least a part thereof) is connected to the plate like structure 31 or fixedly arranged in relation to the plate like structure 31. A force applied to the plate like structure 31 may be generated by the inertia of the part of the electrodynamic actuator 17b, 17c which is moved in relation to the plate like structure 31 (which is the magnet system 22 in case of FIG. 22 and the movable part 34 of the magnet system 22 in case of FIG. 23) or because the part of the electrodynamic actuator 17b, 17c which is moved in relation to the plate like structure 31 is fixed to another part (e.g. to a housing of a device, which the electrodynamic actuator 17b, 17c is built into).

It should also be noted that the arm arrangement 28 can be seen as a spring arrangement in case that the electrodynamic actuator 17b, 17c is connected to a backside of a plate like structure 31 and can be seen as a suspension system in case that the electrodynamic actuator 17a is connected to a backside of a membrane 18.

In general, a speaker 21 or an electrodynamic transducer 32a, 32b (or output device) of the kind disclosed hereinbefore produces an average sound pressure level of at least 50 dB_SPL in a frequency range from 100 Hz to 15 kHz measured in an orthogonal distance of 10 cm from the sound emanating surface S. In particular, the above average sound pressure level is measured at 1 W electrical power more particularly at the nominal impedance.

It should be noted that the invention is not limited to the above-mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application. Although numerous embodiments of this invention have been described above with a certain degree of particularity, those skilled in the art could make numerous alterations to the disclosed embodiments without departing from the spirit or scope of this disclosure.

It should also be noted that the Figs. are not necessarily drawn to scale and the depicted parts may be larger or smaller in reality.

### LIST OF REFERENCES

1a . . . 1d voice coil

2 standard-height section of voice coil

3a . . . 3d recess in voice coil

4a . . . 4g winding

5 insulating adhesive

6 tool

7 laser

8 welding joint

9 electrical conductor

10, 10a, 10b stack of windings

11 lower mold part

12 upper mold part

13 groove

14a, 14b protrusion

15 lower press plate

16 upper press plate

17a . . . 17c electrodynamic actuator

18 membrane

19 flexible membrane part

20 rigid membrane part

21 speaker

22 magnet system

23 center magnet

24 outer magnets

25 center top plate

26 outer top plate

27 bottom plate

28 arm arrangement

29a, 29b arm sub arrangement

30 frame

31 plate like structure

32a, 32b electrodynamic transducer

33 fixed part of magnet system

34 movable part of magnet system

35 outer ring

A coil axis

B1 first section

B2 second section

C circumferential line

D cross sectional plane

E excursion direction

F1 . . . F6 folding line

G

L laser beam

M magnetic field

S sound emanating surface

T1, T2 terminal

h1, h2 height of voice coil

w1 w2 width of electrical conductor

1. A method of manufacturing a voice coil (1a . . . 1d) having an electrical conductor (9) in the shape of loops or windings (4a . . . 4g) running around a coil axis (A) along a circumferential line (C),
wherein different windings (4a . . . 4g) in a first section (B1) of the circumferential line (C) are arranged one above the other when viewed in a cross sectional plane (D) perpendicular to the circumferential line (C) and when the coil axis (A) indicates a height direction and
wherein said different windings (4a . . . 4g) in a second section (B2) of the circumferential line (C) are arranged next to each other when viewed in said cross sectional plane (D),
comprising the steps of
arranging a first and a second winding (4a, 4a′, 4b) of said windings (4a . . . 4g) over one another but offset sideways to each other in the second section (B2) in a first step, and
a) pressing the first winding (4a, 4a′) into a height position of the second winding (4b) in the second section (B2) in a second step or
b) folding the first winding (4a, 4a′) into a height position of the second winding (4b) in the second section (B2) in a second step or
c) moving the first winding (4a, 4a′) into a height position of the second winding (4b) by means of combined folding and pressing in the second section (B2) in a second step.

2. The method as claimed in claim 1, characterized in that said windings (4a . . . 4g) are formed by winding the electrical conductor (9).

3. The method as claimed in claim 1, characterized in that said windings (4a . . . 4g) are formed by cutting, stamping or etching a metal sheet or metal foil which are
inter-connected by welding or soldering and/or
folded on top of one another.

4. The method as claimed in claim 1, characterized in that the electrical conductor (9) is made up from or comprises aluminum and is hardened and annealed in the region of a folding or bending.

5. The method as claimed in claim 1, characterized in that the first winding (4a′) of said windings (4a . . . 4g) performs a lateral movement transverse to the coil axis (A) in the second section (B2) during one of the steps a) to c).

6. The method as claimed in claim 1, characterized in that
the first winding (4a′) of said windings (4a . . . 4g) protrudes outwards away from the coil axis (A) before performing one of the steps a) to c) and performs an inward lateral movement transverse to the coil axis (A) in the second section (B2) during said one of the steps a) to c) or
the first winding (4a′) of said windings (4a . . . 4g) protrudes inwards to the coil axis (A) before performing one of the steps a) to c) and performs an outward lateral movement transverse to the coil axis (A) in the second section (B2) during said one of the steps a) to c).

7. The method as claimed in claim 1, characterized in the steps of:
i) cutting the electrical conductor (9) out of a metallic foil;
ii) forming an insulation layer on the electrical conductor (9);
iii) making a stack (10, 10a, 10b) of windings (4a . . . 4g) from the electrical conductor (9) by
stacking of separate windings (4a . . . 4g) and electrically connecting the stacked separate windings (4a . . . 4g) and/or
folding of the electrical conductor (9);
iv) applying an adhesive (5) between the windings (4a . . . 4g) of the stack (10, 10a, 10b) and
v) forming the windings (4a . . . 4g) in the second section (B2) or in the second sections (B2) according to the process steps of any one of cases a) to c).

8. The method as claimed in claim 1, characterized in that a plurality of windings (4a . . . 4g) are formed in a single process step according to cases a) to c).

9. An electrodynamic actuator (17a . . . 17c), which is designed to be connected to a backside of a plate like structure (31) or membrane (18) opposite to a sound emanating surface (S) of the plate like structure (31) or the membrane (18) and which comprises
at least one voice coil (1a . . . 1d), which has an electrical conductor (9) in the shape of loops or windings (4a . . . 4g) running around a coil axis (A) along a circumferential line (C) in a loop section and which in particular is manufactured by the method as claimed in claim 1, and
a magnet system (22) being designed to generate a magnetic field (M) transverse to the conductor (9) in a loop section of the at least one voice coil (1a . . . 1d),
wherein different windings (4a . . . 4g) of the electrical conductor (9) in a first section (B1) of the circumferential line (C) are arranged one above the other when viewed in a cross sectional plane (D) perpendicular to the circumferential line (C) and when the coil axis (A) indicates a height direction and
wherein said different windings (4a . . . 4g) of the electrical conductor (9) in a second section (B2) of the circumferential line (C) are arranged next to each other when viewed in said cross sectional plane (D).

10. The electrodynamic actuator (17a . . . 17c) as claimed in claim 9, characterized in that the first section (B1) or a plurality of first sections (B1) in total involves at least 50% of the circumferential line (C) and the second section (B2) or a plurality of second sections (B2) in total involves 50% at most of the circumferential line (C).

11. The electrodynamic actuator (17a . . . 17c) as claimed in claim 9, characterized in that the conductor (9) has a circular cross section or a rectangular cross section.

12. The electrodynamic actuator (17a . . . 17c) as claimed in claim 9, characterized in that in the first section (B1) more different windings (4a . . . 4g) are arranged one above the other than in the second section (B2) and that in the second section (B2) more different windings (4a . . . 4g) are arranged next to each other than in the first section (B1) when viewed in said cross sectional plane (D) perpendicular to the circumferential line (C) and when the coil axis (A) indicates a height direction.

13. The electrodynamic actuator (17a . . . 17c) as claimed in claim 9, characterized in that all windings (4a . . . 4g) in the first section (B1) of the circumferential line (C) are arranged one above the other when viewed in said cross sectional plane (D) perpendicular to the circumferential line (C) and when the coil axis (A) indicates a height direction.

14. The electrodynamic actuator (17a . . . 17c) as claimed in claim 9, characterized in that
a first part of the windings (4a . . . 4g) in the second section (B2) of the circumferential line (C) are arranged next to each other when viewed in said cross sectional plane (D) perpendicular to the circumferential line (C) and
a remaining second part of the windings (4a . . . 4g) in the second section (B2) of the circumferential line (C) are arranged on top of one another when viewed in said cross sectional plane (D).

15. The electrodynamic actuator (17a . . . 17c) as claimed in claim 9, characterized in that a virtual line, which is arranged in said cross sectional plane (D) perpendicular to the circumferential line (C) and which is oriented perpendicular to the coil axis (A), indicates a width direction and in that a width (w1, w2) of the conductor (9) is the same in the first section (B1) and in the second section (B2).

16. The electrodynamic actuator (17a . . . 17c) as claimed in claim 9, characterized in that a virtual line, which is arranged in said cross sectional plane (D) perpendicular to the circumferential line (C) and which is oriented perpendicular to the coil axis (A), indicates a width direction and in that a width (w1) of the conductor (9) in the first section (B1) is larger than that a width (w2) of the conductor (9) in the second section (B2).

17. The electrodynamic actuator (17a . . . 17c) as claimed in claim 9, characterized in that a virtual line, which is arranged in said cross sectional plane (D) perpendicular to the circumferential line (C) and which is oriented perpendicular to the coil axis (A), indicates a width direction and in that a total width of the windings (4a . . . 4g) is the same in the first section (B1) and in the second section (B2).

18. The electrodynamic actuator (17a . . . 17c) as claimed in claim 9, characterized in that exactly two windings (4a, 4a′, 4b) of said windings (4a . . . 4g ) are arranged next to each other at a particular height level in the second section (B2) or in that more than two windings of said windings (4a . . . 4g) are arranged next to each other at a particular height level in the second section (B2).

19. A speaker (21), characterized by an electrodynamic actuator (17a . . . 17c) as claimed in claim 9 and a membrane (18), which is fixed to the at least one voice coil (1a . . . 1d) and to the magnet system (22).

20. The electrodynamic actuator (17a . . . 17c) as claimed in to claim 9, wherein the at least one voice coil (1a . . . 1d) or the magnet system (22) comprises a flat mounting surface, which is intended to be connected to the backside of the plate like structure (31) opposite to a sound emanating surface (S) of the plate like structure (31), wherein said backside is oriented perpendicularly to the coil axis (A).

21. An electrodynamic transducer (32a, 32b), comprising a plate like structure (31) with a sound emanating surface (S) and a backside opposite to the sound emanating surface (S) and comprising an electrodynamic actuator (17a . . . 17c) connected to said backside, characterized in that the electrodynamic actuator (17a . . . 17c) is designed according to claim 9.

22. The electrodynamic transducer (32a, 32b) as claimed in claim 21 characterized in that an average sound pressure level of the electrodynamic transducer (32a, 32b) measured in an orthogonal distance of 10 cm from the sound emanating surface (S) is at least 50 dB_SPL in a frequency range from 100 Hz to 15 kHz.

23. An output device characterized in that the plate like structure (25) as claimed in claim 22 is embodied as a display and that the electrodynamic actuator (1a . . . 1c) is connected to the backside of the display.
